(19) United States
(12) Patent Application Publication
(10) Pub. No.: US 2012/0279078 A1
(43) Pub. Date: Nov. 8, 2012

(54) Tilt Sensor

(75) Inventor: Hsin-Tuan Hsiao, New Taipei City (TW)

(73) Assignee: EVERLIGHT ELECTRONICS CO., LTD., New Taipei City (TW)

(21) Appl. No.: 13/463,174

(22) Filed: May 3, 2012

(30) Foreign Application Priority Data
May 6, 2011 (CN) 201110117538.7

(51) Int. Cl. G01C 9/06

(52) U.S. Cl. 33/366.23

(57) ABSTRACT

A tilt sensor capable of sensing tilt in multiple directions includes a backplane, a base, a cover, and a moving component. A light emitting component and light sensing components are disposed on the backplane. The base, disposed on the backplane, includes a recess the bottom of which having a plurality of through-holes. The through-holds expose the light emitting and light sensing components. The cover, disposed on the base, covers the recess. The moving component, disposed in the recess and between the base and the cover, includes a shelter portion where center of gravity of the moving component is located. The moving component moves in directions toward which the tilt sensor is titled, and the shelter portion covers some of the through-holes and blocks light to or from the light emitting and light sensing components. The moving component is highly sensitive and not subject to malfunction caused by friction-induced static electricity.

### CROSS-REFERENCE TO RELATED APPLICATION

This application claims the priority benefit of Chinese Patent Application No. 201110117538.7, filed on May 6, 2011. The entirety of the above-identified patent application is hereby incorporated by reference and made a part of this specification.

### BACKGROUND

1. Technical Field

The present invention relates to tilt sensors and, more particularly, to a type of tilt sensors that can be implemented in devices such as digital cameras and notebook computers with tilt sensing applications.

2. Description of Related Art

Tilt sensors are nowadays widely used in devices such as digital cameras and notebook computers with tilt sensing applications. When the device is tilted to the left or right or placed upside down, a tilt sensor therein can detect a tilted state of the device.

Japan Patent Application Publication No. JPA-2007139643 describes a tilt sensor that is composed of a backplane, a base, a rotating body, and a reflection cover. A light emitting component and a light sensing component are disposed on the backplane. The base is also disposed on the backplane. The base includes a recess wherein the bottom of which has a plurality of through-holes. The light emitting component emits light through one or more of the through-holes, and the light sensing component receives light through one or more of the through-holes. The rotating body is disposed in the recess of the base and rotates correspondingly in response to tilting of the tilt sensor. As the rotating body rotates in the recess, the rotating body prevents the light emitting component and the light sensing component from emitting light and receiving light, respectively, through at least one of the through-holes. The reflection cover is affixed to the base and includes a reflective coating that reflects at least a portion of the light emitted by the light emitting component, thereby allowing the light receiving component to receive the emitted light when the rotating body is not blocking one or more of the through-holds.

The function of the rotating body of the above-described tilt sensor is for blocking the through-holes to prevent the light emitting component and the light sensing component from emitting light and receiving light, respectively. The structure of the rotating body typically is a small disc or a small ball so that it can rotate freely in the recess of the base. As the volume of the rotating body tends to be small, static electricity may be easily generated due to friction, thereby undesirably causing malfunction in sensing or reduced sensitivity, or both.

### SUMMARY

An objective of the present invention is to provide a tilt sensor with high sensitivity and which overcomes the shortcomings associated with the aforementioned approach.

According to one aspect, a tilt sensor capable of sensing tilt in multiple directions may comprise a backplane, a base, a cover, and a moving component. The backplane may have a light emitting component, a first light sensing component, and a second light sensing component disposed thereon. The base may be disposed on the backplane, and may include a recess. A bottom surface of the recess may include a plurality of through-holes thereon to expose the light emitting component, the first light sensing component, and the second light sensing component. The cover may be disposed on the base and may cover the recess. The moving component may be disposed in the recess and between the base and the cover, and may include a shelter portion where a center of gravity of the moving component is located. The shelter portion may point toward a direction of gravity as the moving component moves in a direction corresponding to a direction in which the tilt sensor is tilted such that light emitted by the light emitting component is either received by at least one of the first light sensing component and the second light sensing component or blocked to be prevented from being received by the first light sensing component and the second light sensing component.

In one embodiment, the moving component may further comprise a reflection portion that reflects at least a portion of the light emitted by the light emitting component such that the reflected light is received by at least one of the first light sensing component and the second light sensing component.

In one embodiment, the shelter portion of the moving component may comprise a protrusion that extends from a surface of the moving component toward a cavity of the recess and that expands from a central location of the moving component toward a periphery thereof.

In one embodiment, a maximum cross-sectional area of the moving component may be substantially the same as a maximum cross-sectional area of the recess.

In one embodiment, one of the bottom surface of the recess and the moving component may further include an axial rod, and the other one of bottom surface of the recess and the moving component may further include an indentation that receives a distal end of the axial rod.

In one embodiment, the moving component and the recess may be engaged to each other with a sliding track and a groove thereof.

In one embodiment, the moving component may include the groove around a periphery thereof, and the recess may include the sliding track around an internal circumference thereof.

In one embodiment, the light emitting component may comprise a red light emitting diode, and the first and second light sensing components may respectively comprise a phototransistor.

In one embodiment, a surface of the cover may include an arc-shaped protrusion.

According to another aspect, a tilt sensor may comprise a backplane, a base, a cover and a moving component. The backplane may include a light emitting component, a first light sensing component, and a second light sensing component disposed thereon. The light emitting component may be configured to emit light, and the first and the second light sensing components may be configured to receive light. The base may be disposed on the backplane, and may include a recess. A bottom surface of the recess may include a plurality of light-transmissive regions respectively aligned with the light emitting component, the first light sensing component, and the second light sensing component. The cover may be disposed on the base and covering the recess. The moving component may have an eccentric structure, and may be disposed in the recess and between the base and the cover. The moving component may include a reflection portion configured to reflect light and a shelter portion configured to block light and being where a center of gravity of the moving component is located. The shelter portion may point toward a direction of gravity as the moving component moves in a direction corresponding to a direction in which the tilt sensor is tilted such that either at least a portion of light emitted by the light emitting component and reflected by the reflection portion is received by at least one of the first light sensing component and the second light sensing component or blocked to be prevented from being received by the first light sensing component and the second light sensing component through respective light-transmissive regions, or at least a portion of the light emitted by the light emitting component through a respective light-transmissive region is blocked by the shelter portion to be prevented from being received by the first light sensing component and the second light sensing component.

In one embodiment, the shelter portion of the moving component may comprise a protrusion that extends from a surface of the moving component toward a cavity of the recess and that expands from a central location of the moving component toward a periphery thereof.

In one embodiment, a maximum cross-sectional area of the moving component may be substantially the same as a maximum cross-sectional area of the recess.

In one embodiment, one of the bottom surface of the recess and the moving component may further include an axial rod, and the other one of the bottom surface of the recess and the moving component may further include an indentation that receives a distal end of the axial rod.

In one embodiment, the moving component and the recess may be engaged to each other with a sliding track and a groove thereof.

In one embodiment, the light emitting component may comprise a light emitting diode, and wherein the first and second light sensing components comprise phototransistors.

According to still another aspect, a tilt sensor may comprise a backplane, a base, a cover and a moving component. The backplane may include a light emitting component, a first light sensing component, and a second light sensing component disposed thereon. The base may be disposed on the backplane, and may include a recess. A bottom surface of the recess may include a plurality of through-holes or a plurality of light-transmissive regions thereon that are respectively aligned with the light emitting component, the first light sensing component, and the second light sensing component. The cover may be disposed on the base and covering the recess. The moving component may be disposed in the recess and between the base and the cover. The moving component may include a shelter portion where a center of gravity of the moving component is located. The shelter portion may point toward a direction of gravity as the moving component moves in a direction corresponding to a direction in which the tilt sensor is tilted such that light emitted by the light emitting component is either received by at least one of the first light sensing component and the second light sensing component through respective through-holes or light-transmissive regions, or blocked to be prevented from being received by the first light sensing component and the second light sensing component through the respective through-holes or light-transmissive regions.

In one embodiment, the moving component may further comprise a reflection portion that reflects at least a portion of the light emitted by the light emitting component such that the reflected light is received by at least one of the first light sensing component and the second light sensing component through the respective through-holes or light-transmissive regions.

In one embodiment, the shelter portion of the moving component may comprise a protrusion that extends from a surface of the moving component toward a cavity of the recess and that expands from a central location of the moving component toward a periphery thereof.

In one embodiment, one of the bottom surface of the recess and the moving component may further include an axial rod, and the other one of the bottom surface of the recess and the moving component may further include an indentation that receives a distal end of the axial rod.

In one embodiment, the moving component and the recess may be engaged to each other with a sliding track and a groove thereof.

The moving component of a tilt sensor according to the present disclosure includes both the sheltering function and reflective function, and includes a shelter portion and a reflection portion. The entire moving component is received in the recess of the base and moves substantially frictionlessly therein. The shelter portion covers one or more of the through-holes on the bottom surface of the recess to block light emitted by the light emitting component or to block light from being received by at least one of the first light sensing component and the second light sensing component. The reflection portion reflects the light emitted by the light emitting component so that the reflected light is received by the first light sensing component and the second light sensing component. As the maximum cross-sectional area of the moving component is substantially the same as that of the recess, the moving component is relatively larger and heavier compared to conventional moving parts. Consequently, the moving component according to the present disclosure is less susceptible to malfunction due to static electricity caused by friction, and hence has higher sensitivity.

### BRIEF DESCRIPTION OF THE DRAWINGS

Detailed description of the present invention is provided below with reference to the following figures.

FIG. 1 is a three-dimensional exploded view of a tilt sensor in accordance with an embodiment of the present invention.

FIG. 2 is a cross-sectional view of the tilt sensor in accordance with an embodiment of the present invention.

FIG. 3 is a three-dimensional view of a moving component of a tilt sensor in accordance with an embodiment of the present invention.

FIGS. 4A-4D show four different operational states of a tilt sensor in accordance with an embodiment of the present invention.

### DETAILED DESCRIPTION OF DISCLOSED EMBODIMENTS

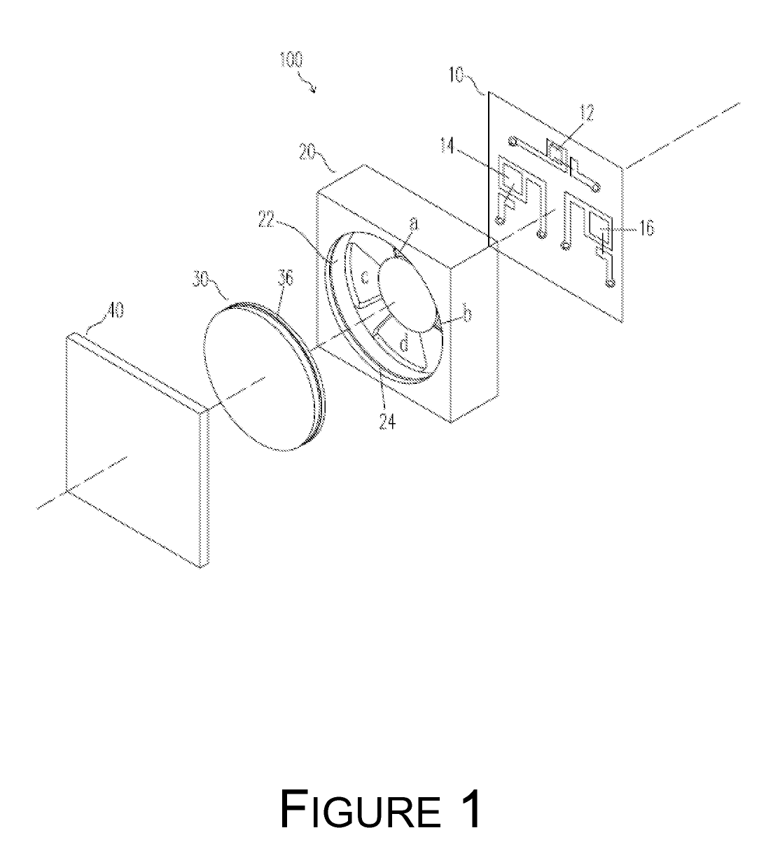

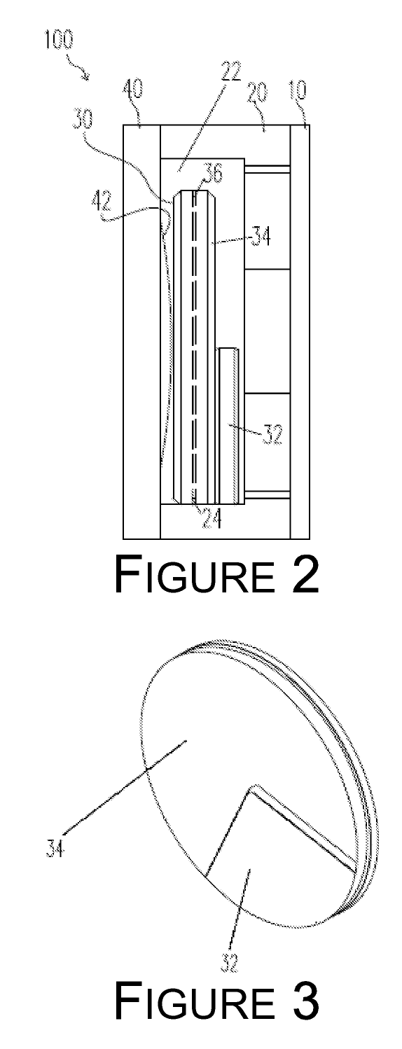

Referring to FIGS. 1 and 2, FIG. 1 illustrates a three-dimensional exploded view of a tilt sensor 100 in accordance with an embodiment of the present invention. FIG. 2 illustrates a cross-sectional view of the tilt sensor 100 in accordance with an embodiment of the present invention. The tilt sensor 100 comprises a backplane 10, a base 20, a moving component 30, and a cover 40. A light emitting component 12, a first light sensing component 14, and a second light sensing component 16 are disposed on the backplane 10. In one embodiment, the backplane 10 is a printed circuit board (PCB) or another type of circuit board. In one embodiment, the light emitting component 12 comprises an infrared light emitting diode, and each of the first and second light sensing components 14, 16 comprises a phototransistor. However, as those skilled in the art would appreciate, in other embodiments one or more of these components may be substitute with respective one or more components having similar functionality. In one embodiment, the light emitting component 12, the first light sensing component 14, and the second light sensing component 16 are disposed on the same surface of the backplane 10. Additionally, the first light sensing component 14 and the second light sensing component 16 may be disposed on two opposite sides of the light emitting component 12. Of course, depending on the need, the first light sensing component 14 and the second light sensing component 16 may be disposed on the same side of the light emitting component 12, and they may be disposed on different surfaces of the backplane 10. The base 20 is disposed on or otherwise affixed to the backplane 10 and includes a recess 22. A plurality of through-holes or light-transmissive regions are provided at the bottom surface of the recess 22 to expose the light emitting component 12, the first light sensing component 14, and the second light sensing component 16 such that the light emitting component 12, the first light sensing component 14, and the second light sensing component 16 emit light and receive light, respectively, through the through-holes or light-transmissive regions. In one embodiment, for the convenience of installation, the quantity of the through-holes is four so that there are through-hole a, through-hole b, through-hole c and through-hole d. When the tilt sensor 100 is in a upright state, three of the through-holes are correspondingly aligned with the light emitting component 12, the first light sensing component 14, and the second light sensing component 16. In another embodiment, the quantity of the through-holes is three, and even so the technical effect of the present invention can still be achieved. The cover 40 is disposed on or otherwise affixed to the base 20 and covers the recess 22. The moving component 30 is disposed in the recess 22 and between the base 20 and the cover 40. A maximum cross-sectional area of the moving component 30 is substantially the same as a maximum cross-sectional area of the recess 22. The moving component 30 performs the functions of reflection and sheltering.

When the tilt sensor 100 is tilted or placed upside down, the moving component 30 moves or rotates with respect to the base 20, and thereby senses a state that the tilt sensor 100 is in. In one embodiment, for the purpose that that the moving component 30 can be more accurately placed inside the recess 22 for the moving component 30 to move or rotate with respect to the base 20, the moving component 30 includes a groove 36 around a periphery thereof and the recess 22 includes a sliding track 24 around an internal circumference thereof. The sliding track 24 is engaged or otherwise embedded in the groove 36, thus preventing the moving component 30 from tilting when rotating. Alternatively, the moving component 30 may include a sliding track around the periphery thereof and the recess 22 may include a groove around the internal circumference thereof. However, as those skilled in the art would appreciate, in other embodiments, one or more of these components or features may be substitute with respective one or more components or features having similar functionality.

Referring to FIG. 2, the moving component 30 includes a shelter portion 32 and a reflection portion 34. A surface of the cover 40 includes an arc-shaped protrusion 42 that fixes the moving component 30 to prevent the moving component 30 from tilting inside the base 20. In another embodiment, a location on the moving component 30 that corresponds to the protrusion 42 includes a recess (not shown) that further fixes the moving component 30 so that the moving component 30 does not tilt inwardly or outwardly when rotating or moving. In one embodiment, a surface of the cover 40 may be include a recess and a location on the moving component 30 that corresponds to the recess may include an arc-shaped protrusion to achieve the same effect.

For better performance, an axial rod may be disposed at a central portion of the bottom surface of the recess 22 of the base 20 and be perpendicular to the bottom surface of the recess 22. The axial rod extends from the bottom surface of the recess 22 towards the moving component 30 with a length slightly greater than a vertical distance from the bottom surface of the recess 22 to the moving part 30. A central portion of the moving component 30 includes an indentation that receives or otherwise sockets a distal end of the axial rod so that the moving component 30 can smoothly rotate with respect to the base 20. Alternatively, the moving component 30 may include an axial rod and the bottom surface of the recess 22 may include an indentation that receives or otherwise sockets a distal end of the axial rod. Of course, normal operation can still be achieved without the axial rod and the corresponding indentation.

Referring to FIG. 3, a moving component 30 as described above is illustrated therein. The moving component 30 includes a shelter portion 32 and a reflection portion 34. The shelter portion 32 has a maximum cross-sectional area that allows it to cover one through-hole but not two through-holes simultaneously. The center of gravity of the moving component 30 is located at the shelter portion 32 such that the moving component 30 has an eccentric structure. When the tilt sensor 100 is tilted or upside down, the shelter portion 32 is pointed toward a direction of gravity. As a result, the shelter portion 32 can shelter light emitted by the light emitting component 12 or block light from the first light sensing component 14 or the second light sensing component 16. In one embodiment, the shelter portion 32 comprises a protrusion that extends from an internal surface of the moving component 30 toward a cavity of the recess 22 as well as expands from a central location of the moving component 30 toward a periphery thereof. A purpose of such design is to locate the center of gravity of the moving component 30 at the shelter portion 32. The protrusion may be fan-shaped, rectangular, round, semicircular, or may have an irregular shape, but is not limited thereto. Those skilled in the art would appreciate that the protrusion may have any other suitable shape. The reflection portion 34 constitutes the remainder of the moving component 30 excluding the shelter portion 32, and may be made of a reflective metal or a reflective material. The combination of the reflection portion 34 and the shelter portion 32 either allows at least one of the first light sensing component 14 and the second light sensing component 16 to receive light emitted by the light emitting component 12 or blocks the light emitted by the light emitting component 12 so that the first light sensing component 14 and the second light sensing component 16 cannot receive the light emitted by the light emitting component 12. This enables the sensing of the four states associated with the tilt sensor 100 to achieve the technical effect of the present invention.

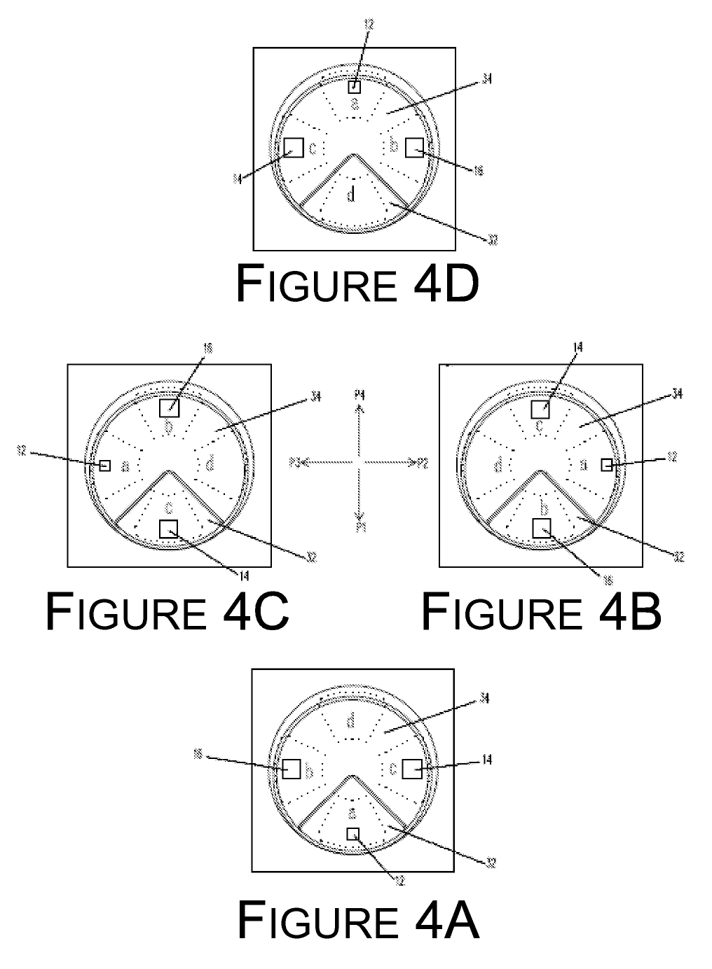

Referring to FIGS. 4A-4D, four operational states of the tilt sensor 100 in accordance with the present invention are illustrated. Detailed description of the four operational states is provided below.

As shown in FIG. 4A, when the tilt sensor 100 is tilted from a horizontal state toward the gravity in a direction P1, the tilt sensor 100 is in an upright state. The shelter portion 32 of the moving component 30 is pointed toward a direction of gravity due to the center of gravity of the moving component 30. At this time the shelter portion 32 blocks the through-hole d, which is not aligned with any of the light emitting component 12, the first light sensing component 14, or the second light sensing component 16. Accordingly, light emitted by the light emitting component 12 can be received by the first light sensing component 14 and the second light sensing component 16, after being reflected by the reflection portion 34 and, consequently, the first light sensing component 14 and the second light sensing component 16 can both detect the light. In other words, it can be determined that the tilt sensor 100 is in an upright state in the direction P1 when the first light sensing component 14 and the second light sensing component 16 both detect the light emitted by the light emitting component 12.

As shown in FIG. 4B, when the tilt sensor 100 is tilted from a horizontal state toward the gravity in a direction P2, the moving component 30 moves substantially frictionlessly in the recess 22 with respect to the base 20. The shelter portion 32 of the moving component 30 is pointed toward a direction of gravity due to the center of gravity of the moving component 30. At this time the shelter portion 32 blocks the through-hole b, which is correspondingly aligned with the second light sensing component 16. Accordingly, light emitted by the light emitting component 12 can be received by the first light sensing component 14 but not the second light sensing component 16, after being reflected by the reflection portion 34, and hence the second light sensing component 16 cannot detect the light. In other words, it can be determined that the tilt sensor 100 is tilted in the direction P2 when the first light sensing component 14, but not the second light sensing component 16, detects the light emitted by the light emitting component 12.

As shown in FIG. 4C, when the tilt sensor 100 is tilted from a horizontal state toward the gravity in a direction P3, the moving component 30 moves substantially frictionlessly in the recess 22 with respect to the base 20. The shelter portion 32 of the moving component 30 is pointed toward a direction of gravity due to the center of gravity of the moving component 30. At this time the shelter portion 32 blocks the through-hole c, which is correspondingly aligned with the first light sensing component 14. Accordingly, light emitted by the light emitting component 12 can be received by the second light sensing component 16 but not the first light sensing component 14, after being reflected by the reflection portion 34, and hence the first light sensing component 14 cannot detect the light. In other words, it can be determined that the tilt sensor 100 is tilted in the direction P3 when the second light sensing component 16, but not the first light sensing component 14, detects the light emitted by the light emitting component 12.

As shown in FIG. 4D, when the tilt sensor 100 is tilted from a horizontal state toward the gravity in a direction P4, the moving component 30 moves substantially frictionlessly in the recess 22 with respect to the base 20. The shelter portion 32 of the moving component 30 is pointed toward a direction of gravity due to the center of gravity of the moving component 30. At this time the shelter portion 32 blocks the through-hole a, which is correspondingly aligned with the light emitting component 12. Accordingly, light emitted by the light emitting component 12 is blocked by the shelter portion 32 and cannot be received by the first light sensing component 14 or the second light sensing component 16, resulting in no light detection by the first light sensing component 14 and the second light sensing component 16. In other words, it can be determined that the tilt sensor 100 is in an upside down state in the direction P4 when neither the first light sensing component 14 nor the second light sensing component 16 detects the light emitted by the light emitting component 12.

The above-described operational states pertain to an embodiment in which the first light sensing component 14 and the second light sensing component 16 are disposed on two opposing sides of the light emitting component 12. When the first light sensing component 14 and the second light sensing component 16 are both disposed on the same side of the light emitting component 12, four different operational states may result correspondingly and thus achieve the technical effect of the present invention.

The moving component 30 of the tilt sensor 100 according to various embodiments of the present invention provides the functions of sheltering and reflection, and includes the shelter portion 32 and the reflection portion 34. The moving component 30 can move substantially frictionlessly in the recess 20 with respect to the base 20. The shelter portion 32 covers one the through-holes on the bottom of the recess 22 to thereby block the light emitted by the light emitting component 12 and/or block light from being received by either or both of the first light sensing component 14 and the second light sensing component 16. The reflection portion 34 reflects at least a portion of the light emitted by the light emitting component 12 for reception by the first light sensing component 14 and/or the second light sensing component 16. The maximum cross-sectional area of the moving component 30 is substantially the same as the maximum cross-sectional area of the recess 22. As the size and weight of the moving component 30 are relatively larger compared to those of conventional design, the proposed design is less susceptible to the effect of friction to result in malfunction due to static electricity and, consequently, has a high degree of sensitivity.

In one embodiment, the moving component provides the functions of sheltering and reflection. The moving component may be a one-piece metallic structure including a shelter portion having a protrusion and a reflection portion.

In one embodiment, the moving component provides the functions of sheltering and reflection. The moving component may be a one-piece non-reflective structure including a shelter portion having a protrusion and a reflection portion. A surface of the reflection portion may be coated with a layer of reflective material, which may be a reflective metal or polymer material.

In one embodiment, the moving component provides the functions of shelter and reflection. The moving component may be a composite structure including a planar shelter portion and a reflection portion. A density of the shelter portion is higher than a density of the reflection portion. The reflection portion may be made of reflective metal or may be coated with a layer of reflective material.

Various embodiments of a tilt sensor in accordance with the present invention are not limited to those described herein. The actual design and implementation of each component of the tilt sensor in accordance with the present invention may vary from the embodiments described herein. Those ordinarily skilled in the art may make various deviations and improvements based on the disclosed embodiments, and such deviations and improvements are still within the scope of the present invention. Accordingly, the scope of protection of a patent issued from the present disclosure is determined by the claims as follows.

What is claimed is:

1. A tilt sensor capable of sensing tilt in multiple directions, the tilt sensor comprising:
a backplane having a light emitting component, a first light sensing component, and a second light sensing component disposed thereon;
a base disposed on the backplane, the base including a recess, a bottom surface of the recess having a plurality of through-holes to expose the light emitting component, the first light sensing component, and the second light sensing component;
a cover disposed on the base and covering the recess; and
a moving component disposed in the recess and between the base and the cover, the moving component including a shelter portion where a center of gravity of the moving component is located, the shelter portion pointed toward a direction of gravity as the moving component moves in a direction corresponding to a direction in which the tilt sensor is tilted such that light emitted by the light emitting component is either received by at least one of the first light sensing component and the second light sensing component or blocked to be prevented from being received by the first light sensing component and the second light sensing component.

2. The tilt sensor as recited in claim 1, wherein the moving component further comprises a reflection portion that reflects at least a portion of the light emitted by the light emitting component such that the reflected light is received by at least one of the first light sensing component and the second light sensing component.

3. The tilt sensor as recited in claim 1, wherein the shelter portion of the moving component comprises a protrusion that extends from a surface of the moving component toward a cavity of the recess and that expands from a central location of the moving component toward a periphery thereof.

4. The tilt sensor as recited in claim 1, wherein a maximum cross-sectional area of the moving component is substantially the same as a maximum cross-sectional area of the recess.

5. The tilt sensor as recited in claim 1, wherein one of the bottom surface of the recess and the moving component further includes an axial rod, and wherein the other one of bottom surface of the recess and the moving component further includes an indentation that receives a distal end of the axial rod.

6. The tilt sensor as recited in claim 1, wherein the moving component and the recess are engaged to each other with a sliding track and a groove thereof.

7. The tile sensor as recited in claim 6, wherein the moving component includes the groove around a periphery thereof, and wherein the recess includes the sliding track around an internal circumference thereof.

8. The tilt sensor as recited in claim 1, wherein the light emitting component comprises an infrared light emitting diode, and wherein the first and second light sensing components respectively comprise a phototransistor.

9. The tilt sensor as recited in claim 1, wherein a surface of the cover includes an arc-shaped protrusion.

10. A tilt sensor, comprising:
a backplane having a light emitting component, a first light sensing component, and a second light sensing component disposed thereon, the light emitting component configured to emit light, the first and the second light sensing components configured to receive light;
a base disposed on the backplane, the base including a recess, a bottom surface of the recess having a plurality of light-transmissive regions respectively aligned with the light emitting component, the first light sensing component, and the second light sensing component;
a cover disposed on the base and covering the recess; and
a moving component having an eccentric structure, the moving component disposed in the recess and between the base and the cover, the moving component including a reflection portion configured to reflect light and a shelter portion configured to block light and being where a center of gravity of the moving component is located, the shelter portion pointed toward a direction of gravity as the moving component moves in a direction corresponding to a direction in which the tilt sensor is tilted such that either (1) at least a portion of light emitted by the light emitting component and reflected by the reflection portion is received by at least one of the first light sensing component and the second light sensing component or blocked to be prevented from being received by the first light sensing component and the second light sensing component through respective light-transmissive regions, or (2) at least a portion of the light emitted by the light emitting component through a respective light-transmissive region is blocked by the shelter portion to be prevented from being received by the first light sensing component and the second light sensing component.

11. The tilt sensor as recited in claim 10, wherein the shelter portion of the moving component comprises a protrusion that extends from a surface of the moving component toward a cavity of the recess and that expands from a central location of the moving component toward a periphery thereof.

12. The tilt sensor as recited in claim 10, wherein a maximum cross-sectional area of the moving component is substantially the same as a maximum cross-sectional area of the recess.

13. The tilt sensor as recited in claim 10, wherein one of the bottom surface of the recess and the moving component further includes an axial rod, and wherein the other one of the bottom surface of the recess and the moving component further includes an indentation that receives a distal end of the axial rod.

14. The tilt sensor as recited in claim 10, wherein the moving component and the recess are engaged to each other with a sliding track and a groove thereof.

15. The tilt sensor as recited in claim 10, wherein the light emitting component comprises an infrared light emitting diode, and wherein the first and second light sensing components respectively comprise a phototransistor.

16. A tilt sensor, comprising:
a backplane having a light emitting component, a first light sensing component, and a second light sensing component disposed thereon;
a base disposed on the backplane, the base including a recess, a bottom surface of the recess having a plurality of through-holes or a plurality of light-transmissive regions thereon that are respectively aligned with the light emitting component, the first light sensing component, and the second light sensing component;
a cover disposed on the base and covering the recess; and
a moving component disposed in the recess and between the base and the cover, the moving component including a shelter portion where a center of gravity of the moving component is located, the shelter portion pointed toward a direction of gravity as the moving component moves in a direction corresponding to a direction in which the tilt sensor is tilted such that light emitted by the light emitting component is either received by at least one of the first light sensing component and the second light sensing component through respective through-holes or light-transmissive regions, or blocked to be prevented from being received by the first light sensing component and the second light sensing component through the respective through-holes or light-transmissive regions.

17. The tilt sensor as recited in claim 16, wherein the moving component further comprises a reflection portion that reflects at least a portion of the light emitted by the light emitting component such that the reflected light is received by at least one of the first light sensing component and the second light sensing component through the respective through-holes or light-transmissive regions.

18. The tilt sensor as recited in claim 16, wherein the shelter portion of the moving component comprises a protrusion that extends from a surface of the moving component toward a cavity of the recess and that expands from a central location of the moving component toward a periphery thereof.

19. The tilt sensor as recited in claim 16, wherein one of the bottom surface of the recess and the moving component further includes an axial rod, and wherein the other one of the bottom surface of the recess and the moving component further includes an indentation that receives a distal end of the axial rod.

20. The tilt sensor as recited in claim 16, wherein the moving component and the recess are engaged to each other with a sliding track and a groove thereof.
